(19) United States
(12) Patent Application Publication
(10) Pub. No.: US 2024/0148064 A1
(43) Pub. Date: May 9, 2024

(54) HEATER ELEMENT AND METHOD OF MANUFACTURING A HEATER ELEMENT

(71) Applicant: Philip Morris Products S.A., Neuchatel (CH)

(72) Inventors: Silvia CAPO, Neuchatel (CH); Marco DOTTOR, Milano (IT); Moritz THIELEN, Stäfa (CH); Pascal SCHLÄPFER, Ebnat-Kappel (CH); Stefan WOLF, Wil (CH)

(73) Assignee: Philip Morris Products S.A., Neuchatel (CH)

(21) Appl. No.: 18/546,689

(22) PCT Filed: Feb. 24, 2022
(86) PCT No.: PCT/EP2022/054701

§ 371 Date: Aug. 16, 2023

(30) Foreign Application Priority Data
Feb. 26, 2021 (EP) 21159769.5

(51) Int. Cl. A24F 40/46; A24F 40/485

(52) U.S. Cl. CPC A24F 40/46; A24F 40/485; A24F 40/20

(57) ABSTRACT

An elongate metallic heater element is provided for an aerosol-generating device, the heater element extending between proximal and distal ends, the proximal end configured for mounting to the device for electrical communication with the device, the heater element including either or both of: a plurality of surface notches formed on a surface of the heater element, and a plurality of sub-surface cavities defined beneath the surface of the heater element, at least some of the plurality of surface notches and the sub-surface cavities of the heater element are provided in an inner region of the heater element extending between the proximal end and 33% of a length of the heater element relative to the proximal end, and in which at least 40% by volume of all of the plurality of surface notches and the sub-surface cavities of the heater element are provided in the inner region.

The present disclosure relates to a heater element suitable for use with an aerosol-generating device. The present disclosure also relates to a method of manufacturing such a heater element.

Heater elements for use as part of an aerosol-generating device are known in the art. More particularly, electrically-powered heater elements are known which generate heat by resistive heating under the action of an electric current. Such electrically-powered resistive heater elements may take the form of a ceramic substrate on which is arranged a metallic resistive heating track. In use, electricity fed to the resistive heating track would induce heating of the track. An aerosol-generating device incorporating such a known resistive heater element may be used with a known aerosol-generating article containing a plug of aerosol-forming substrate. In use, the resistive heater element is inserted within the aerosol-generating article so that the heater element directly contacts the aerosol-forming substrate. The heat imparted to the aerosol-forming substrate from the resistive heater element vaporises constituent elements of the aerosol-forming substrate. On passage through the aerosol-generating article, the vapours evolved from the substrate cool and condense to form an aerosol for inhalation by a user. However, repeated use of the aerosol-generating device with different aerosol-generating articles can result in a gradual build-up of residue on the heater element. This residue can hinder the ability of the heater element to convey heat to the aerosol-forming substrate, and can also impart undesired flavours to vapours evolved from the aerosol-forming substrate. Therefore, the presence of such residue on the heater element can be detrimental to the user experience for the aerosol-generating device. Cleaning may be performed to remove this residue from the surface of the heater element. However, cleaning can result in the application of one or a combination of tensile, compressive and twisting forces being applied to the heater element. As ceramic substrates are inherently brittle, the forces applied to such known ceramic-based heater elements during cleaning can result in the heater element fracturing.

Replacement of the ceramic substrate with a substrate formed of metallic material can help to reduce the likelihood of the heater element fracturing, with metallic materials generally having greater ductility than ceramic materials. However, metallic materials generally possess greater thermal conductivity compared to ceramic materials. When using a metallic material for the substrate of the heater element in place of a ceramic material, the relatively higher thermal conductivity of the metallic substrate can lead to heat conducted into the substrate from the resistive heating track being rapidly conveyed throughout the metallic substrate. The rapid passage of heat throughout the metallic substrate can result in corresponding rapid increases in temperature of the substrate. This increase in substrate temperature can thereby result in overheating of sensitive electronic components of the aerosol-generating device associated with control and operation of the heater element. For example, control circuitry used to control the supply of electrical power to the heater element is often located in close proximity to where the heater element is positioned within the aerosol-generating device. Excessive temperatures in the metallic substrate can therefore be conducted to and damage the sensitive control circuitry. Further, damage to components of the aerosol-generating device can also occur due to heat being radiated from excessively hot regions of the metallic substrate of the heater element.

It is therefore desired to provide an improved resistive heater element which has enhanced heat flow management and can better withstand forces which may be applied to the heater element during cleaning or operation (such as tensile, compressive or twisting forces) without fracturing.

According to a first aspect of the present disclosure, there is provided an elongate metallic heater element for use with an aerosol-generating device. The heater element extends between a proximal end and a distal end. The proximal end is configured for mounting to an aerosol-generating device for electrical communication with the aerosol-generating device. The heater element comprises either or both of: i) a plurality of surface notches formed on a surface of the heater element; and ii) a plurality of sub-surface cavities defined beneath the surface of the heater element.

As used herein, the term “metallic” is used to mean formed predominantly or wholly of one or more metals. So, the term “metallic” encompasses specific metal elements or alloys.

As used herein, the term “aerosol-generating device” is used to describe a device that interacts with an aerosol-forming substrate of an aerosol-generating article to generate an aerosol. Preferably, the aerosol-generating device is a smoking device that interacts with an aerosol-forming substrate of an aerosol-generating article to generate an aerosol that is directly inhalable into a user's lungs thorough the user's mouth. The aerosol-generating device may be a holder for a smoking article. Preferably, the aerosol-generating article is a smoking article that generates an aerosol that is directly inhalable into a user's lungs through the user's mouth. More preferably, the aerosol-generating article is a smoking article that generates a nicotine-containing aerosol that is directly inhalable into a user's lungs through the user's mouth.

As used herein, the term “aerosol-forming substrate” denotes a substrate consisting of or comprising an aerosol-forming material that is capable of releasing volatile compounds upon heating to generate an aerosol.

The provision of the metallic heater element with a plurality of surface notches formed on a surface of the heater element reduces the rate of heat transfer through the heater element at the location of the surface notches compared to the same heater element lacking any such notches. The effect of forming notches in the metallic heater element is to remove thermally-conductive metal material from the heater element which would otherwise be present to conduct heat. Therefore, the rate of heat transfer and resulting temperatures in one or more regions of the heater element can be controlled by the presence of such surface notches in the vicinity of those one or more regions.

The provision of the metallic heater element with a plurality of sub-surface cavities may provide the same advantages described above for the surface notches. The use of sub-surface cavities may be particularly beneficial in maintaining flexural rigidity of the heater element, due to the inherent constraining effect of the metallic substrate material which would enclose each sub-surface cavity.

The use of surface notches or sub-surface cavities can be contrasted with the use of through-holes in the metallic heater element. The use of a surface notch or a sub-surface cavity of a given volume may maintain a higher level of flexural rigidity in the heater element compared to a through-hole having the same volume. As used herein, the term “through-hole” refers to where an opening extends through and between opposing surfaces of the heater element.

A surface notch would be an open feature, in that a notch would open onto a surface of the heater element. In contrast, a sub-surface cavity would be a closed feature, in that it would be enclosed and hidden from view beneath a surface of the heater element.

In summary, the use of a metallic heater element provided with a plurality of either or both surface notches and sub-surface cavities provides improved thermal management to the heater element. These advantages co-exist alongside the ductility which results from the heater element being formed of a metallic material. This inherent ductility reduces the likelihood of the heater element fracturing when subjected to tensile, compressive, or twisting forces during operational use or cleaning. Further, the surface notches and sub-surface cavities reduce the mass of the heater element compared to the same heater element lacking any such notches or cavities.

The distribution and size of the surface notches and sub-surface cavities may be selected and arranged to provide heat management and temperature control of one or more specific regions of the metallic heater element, whilst retaining sufficient flexural rigidity in the heater element to enable the element to withstand forces encountered during operational use and cleaning. For example, where the metallic heater element is intended to be inserted within the aerosol-forming substrate of an aerosol-generating article, the heater element should possess sufficient flexural rigidity to withstand insertion without the heater element buckling.

The individual notches and cavities may be defined by one or more curved surfaces. By way of example, the surface of a notch may correspond to part of the surface of a sphere or an ellipsoid. By way of further example, the enclosed surface of a cavity may correspond to the surface of a sphere or an ellipsoid. The use of notches and cavities which consist of curved surfaces also reduces the likelihood of individual notches and cavities acting as mechanical stress-raising features when the heater element is subjected to tensile, compressive or twisting forces. However, other shapes for the notches and cavities may also be employed. By way of example, the surface notches may be circular in plan, each defining a cylindrical bore extending into the surface of the heater element. Alternatively, the surface notches may be hexagonal in plan, defining a hexagonal-shaped bore extending into the surface of the heater element.

The heater element may comprise a metallic substrate and one or more resistive heating tracks, the one or more resistive heating tracks arranged on the metallic substrate. In turn, the plurality of surface notches and sub-surface cavities of the heater element may be formed on or within the metallic substrate. In use, electric current may be fed to the one or more resistive heating tracks of the heater element via the proximal end of the heater element. The flow of electric current along the one or more resistive tracks results in heating of the tracks by resistance heating (also known as Ohmic heating or Joule heating).

Metallic materials of the metallic heater element may include titanium or stainless steel. Further, Inconel® alloy 617 may also be suitable, possessing a combination of high temperature strength and oxidation resistance. For Inconel® alloy 617, the nickel and chromium content provides oxidation resistance, with the aluminium and nickel content also imparting high temperature oxidation resistance. By way of example, the heater element may take the form of a metallic substrate formed of titanium, stainless steel or Inconel® alloy 617, with one or more resistive heating tracks arranged on one or more surfaces of the substrate. Other metallic materials may be used for the metallic heater element, with the materials chosen dependent upon factors which can include flexural rigidity, thermal conductivity, oxidation resistance and chemical reactivity.

The plurality of surface notches and sub-surface cavities of the heater element may occupy a cumulative volume of between 15% to 30% of the volume of a corresponding heater element free of any such notches and cavities. As used herein, the term “cumulative volume” refers to the summation of the volume occupied by all of the surface notches and sub-surface cavities formed in the heater element. In general, the greater the cumulative volume of the heater element which is occupied by the surface notches or sub-surface cavities, the greater the corresponding reduction in conductive heat transfer through the metallic heater element during use. However, the greater the cumulative volume occupied by the notches or cavities, the less the flexural rigidity of the heater element. Confining the cumulative volume to between 15% to 30% provides a balance between the two conflicting desires of i) reducing excessive heat flow and resulting high temperatures in the metallic heater element, and ii) retaining sufficient flexural rigidity in the heater element to enable the element to withstand axial compressive forces without simply buckling. Conveniently however, the plurality of surface notches and sub-surface cavities of the heater element may occupy a cumulative volume of between 17% to 26% of the volume of a corresponding heater element free of any such notches and cavities.

The heater element may be entirely free of any through-holes extending through a thickness of the heater element. In contrast with the surface notches and sub-surface cavities, a “through-hole” would extend all the way through and between opposing surfaces of the heater element.

Alternatively however, the heater element may further comprise a plurality of through-holes extending through a thickness of the heater element. In this manner, the heater element may include a combination of different categories of features which correspond to removal of metallic material from the metallic heater element to provide improved thermal management of the heater element in use. For example, the heater element may include a plurality of through-holes alongside either a plurality of surface notches, or a plurality of sub-surface cavities. Alternatively, the heater element may include all of a plurality of through-holes, a plurality of surface notches and a plurality of sub-surface cavities. The plurality of through-holes may be distributed along the length of the heater element. Individual through-holes may allow for the flow of air across the heater element during use.

The plurality of surface notches and sub-surface cavities of the heater element may be formed to define one or more honeycomb arrangements. As used herein, the term “honeycomb arrangement” refers to a repeating pattern of the notches or cavities. The honeycomb arrangement may be two-dimensional; for example, the honeycomb arrangement may be defined by a discrete layer of surface notches or sub-surface cavities extending along two axes orthogonal to each other. Alternatively, the honeycomb arrangement may be three-dimensional. The use of such a honeycomb arrangement ensures that the region of the heater element in which the honeycomb arrangement is situated has near uniform thermal and structural properties.

The heater element may comprise the plurality of surface notches and be entirely free of any sub-surface cavities. Alternatively, the heater element may comprise the plurality of sub-surface cavities and be entirely free of any surface notches.

At least some of the plurality of surface notches and sub-surface cavities of the heater element may be provided in an inner region of the heater element, the inner region extending between the proximal end and 33% of the length of the heater element relative to the proximal end. As the proximal end is configured for mounting to an aerosol-generating device, ensuring that the inner region of the heater element contains at least some of the surface notches and sub-surface cavities may help to avoid overheating of electronic components of the aerosol-generating device located adjacent to the proximal end. As control electronics of the aerosol-generating device will often be located at or close to the proximal end of the heater element, providing notches or cavities in the inner region of the heater element can avoid excessive temperatures developing in this region of the heater element and in neighbouring components of the aerosol-generating device. Conveniently, at least 40% by volume, or at least 50% by volume, or at least 60% by volume, or at least 70% by volume, or at least 80% by volume of all of the plurality of surface notches and sub-surface cavities of the heater element are provided in the inner region. The provision of such a high volumetric proportion of surface notches and/or surface cavities provides a barrier to conductive heat transfer through the metallic material of the heater element in the inner region and thereby enhances thermal protection to components of the aerosol-generating device in close proximity to the inner region of the heater element. In one example, all of the plurality of surface notches and sub-surface cavities of the heater element may be provided in the inner region of the heater element.

Where at least some of the plurality of surface notches and sub-surface cavities of the heater element are provided in the inner region of the heater element (as described in the preceding paragraph), the surface notches and sub-surface cavities of the inner region may extend laterally across at least 90%, or at least 95% of the lateral width of the heater element. Such an arrangement of notches or cavities helps to provide a barrier to conductive heat transfer through the metallic substrate close to the proximal end, with the barrier extending across nearly all of the lateral width of the heater element.

Where some of the plurality of surface notches and sub-surface cavities of the heater element are provided in the inner region of the heater element (as described in the preceding paragraphs), some of the plurality of surface notches and sub-surface cavities of the heater element may also be provided in a middle region of the heater element, the middle region extending between 33% and 90% of the length of the elongate heater element relative to the proximal end. Including surface notches or sub-surface cavities in the middle region of the heater element in addition to those in the inner region may provide a more gradual change in heat transfer rate through the heater element when progressing from one region of the heater element to another. Ensuring such gradual changes in heat transfer rate through the heater element may be beneficial in avoiding excessive thermal stresses being developed in the metallic material of the heater element.

The heater element may extend along a longitudinal axis and laterally outwards from the longitudinal axis to define a blade having opposed first and second elongate surfaces. Providing the heater element in the form of a blade makes the element particularly suitable for insertion through and within the aerosol-forming substrate of an aerosol-generating article. The heater element may further comprise a resistive heating track arranged on the first elongate surface, the heater element comprising a plurality of the surface notches on the second elongate surface, in which the surface notches on the second elongate surface form at least 80% by volume of all of the plurality of surface notches of the heater element. The second elongate surface may be free of any resistive heating track. As discussed in preceding paragraphs, the passage of electric current along the resistive heating track would result in resistive heating of the track. The first elongate surface may be substantially free of surface notches. By way of example, any surface notches of the heater element may instead be provided on the second elongate surface.

The plurality of surface notches and sub-surface cavities of the heater element may be arranged in one or more laterally-symmetric groups. The one or more laterally-symmetric groups may comprise a first group, a second group and a third group. The first group may be symmetrically disposed about the longitudinal axis and extend laterally across at least 90%, or at least 95% of the lateral width of the heater element in an inner region of the heater element. The inner region may extend between the proximal end and 33% of the length of the heater element relative to the proximal end. The second and third groups may be symmetrically disposed from each other on either side of the longitudinal axis in a middle region of the heater element, the middle region extending between 33% and 90% of the length of the heater element relative to the proximal end. The second and third groups may be axially spaced from the first group. The second and third groups may join each other at the longitudinal axis.

Preferably, the heater element is configured to be removably mountable to the aerosol-generating device. In this way, the heater element can be removed for cleaning before being remounted. Further, the heater element may be removed and swapped with a replacement heater element.

In a second aspect of the present disclosure, there is provided an aerosol-generating device configured to receive an aerosol-forming substrate. The aerosol-generating device comprises an elongate metallic heater element as described in relation to the first aspect of the present disclosure. The aerosol-generating device also comprises a power source. The proximal end of the heater element is mounted to a mounting location of the aerosol-generating device. The power source is in electrical communication with the heater element so as to, in use, resistively heat the heater element.

The power source is preferably in the form of a battery, thereby providing a source of electrical power to the aerosol-generating device and helping to make the device portable. Conveniently, the battery is rechargeable; by way of example, a lithium ion battery may be used as the power source.

The aerosol-generating device may be configured such that, in use with an aerosol-forming substrate received in the device, the heater element extends within the aerosol-forming substrate to heat the aerosol-forming substrate and generate an inhalable aerosol therefrom. By way of example, the heater element may be formed as a blade as described in the preceding paragraphs. The distal end of the blade may terminate in a point, thereby assisting in entry of the blade into the aerosol-generating substrate. One or more longitudinal edges of the blade may also be sharpened.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article.

Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

In a third aspect of the present disclosure, there is provided a method of manufacturing a heater element. The method comprises providing a metallic substrate and forming either or both of i) a plurality of surface notches on a surface of the metallic substrate; and ii) a plurality of sub-surface cavities defined beneath the surface of the metallic substrate.

A plurality of metallic blanks may first be cut from a sheet of the metallic material, with each blank forming the “metallic substrate” for a given heater element. Conveniently, the surface notches and sub-surface cavities may be formed in the sheet of metallic material prior to cutting the sheet into individual blanks. Alternatively, the surface notches and sub-surface cavities may be formed in each blank after being cut from the sheet of metallic material.

Advantageously, the forming step may comprise etching of the metallic substrate to form the plurality of surface notches. By way of example, a chemical or mechanical etching process may be used to form the notches in the surface of the substrate. Chlorine etching is an example of a suitable chemical etching process. Mechanical etching may take the form of the notches being machined into the surface of the substrate.

Preferably, the manufactured heater element resulting from the method is in accordance with the metallic heater element described in the preceding paragraphs in relation to the first aspect of the present disclosure.

In a fourth aspect of the present disclosure, there is provided a method of manufacturing a heater element. The method comprises providing a supply of metallic material; additively manufacturing the heater element from the supply of metallic material to progressively form the heater element to comprise either or both of: i) a plurality of surface notches on a surface of the heater element; and ii) a plurality of sub-surface cavities defined beneath the surface of the heater element.

The use of additive manufacturing to form the heater element is particularly beneficial in enabling the formation of hidden structural features, such as the sub-surface cavities. By way of example, the metallic material may be provided in powder form, or alternatively as a slurry of powder and liquid. Conveniently, the additive manufacturing step may comprise three-dimensional screen printing.

Preferably, the manufactured heater element resulting from the method is in accordance with the metallic heater element described in the preceding paragraphs in relation to the first aspect of the present disclosure.

The invention is defined in the claims. However, below there is provided a non-exhaustive list of non-limiting examples. Any one or more of the features of these examples may be combined with any one or more features of another example, embodiment, or aspect described herein.

Example Ex1: An elongate metallic heater element for use with an aerosol-generating device, the heater element extending between a proximal end and a distal end, the proximal end configured for mounting to an aerosol-generating device for electrical communication with the aerosol-generating device; wherein the heater element comprises either or both of: i) a plurality of surface notches formed on a surface of the heater element; and ii) a plurality of sub-surface cavities defined beneath the surface of the heater element.

Example Ex2: An elongate metallic heater element according to Ex1, in which the heater element comprises a metallic substrate and one or more resistive heating tracks, the one or more resistive heating tracks arranged on the metallic substrate, wherein the plurality of surface notches and sub-surface cavities of the heater element are respectively formed on or within the metallic substrate.

Example Ex3: An elongate metallic heater element according to either one of Ex1 or Ex2, in which the plurality of surface notches and sub-surface cavities of the heater element occupy a cumulative volume of between 15% to 30% of the volume of a corresponding heater element free of any such notches and cavities.

Example Ex4: An elongate metallic heater element according to Ex3, in which the plurality of surface notches and sub-surface cavities of the heater element occupy a cumulative volume of between 17% to 26% of the volume of a corresponding heater element free of any such notches and cavities.

Example Ex5: An elongate metallic heater element according to any one of Ex1 to Ex4, in which the heater element is free of any through-holes extending through a thickness of the heater element.

Example Ex6: An elongate metallic heater element according to any one of Ex1 to Ex4, in which the heater element further comprises a plurality of through-holes extending through a thickness of the heater element.

Example Ex7: An elongate metallic heater element according to Ex6, in which the plurality of through-holes are distributed along the length of the heater element.

Example Ex8: An elongate metallic heater element according to any one of Ex1 to Ex6, in which the plurality of surface notches and sub-surface cavities of the heater element are formed to define one or more honeycomb arrangements.

Example Ex9: An elongate metallic heater element according to any one of Ex1 to Ex8, in which the heater element comprises the plurality of surface notches and is free of any sub-surface cavities.

Example Ex10: An elongate metallic heater element according to any one of Ex1 to Ex8, in which the heater element comprises the plurality of sub-surface cavities and is free of any surface notches.

Example Ex11: An elongate metallic heater element according to any one of Ex1 to Ex10, in which at least some of the plurality of surface notches and sub-surface cavities of the heater element are provided in an inner region of the heater element, the inner region extending between the proximal end and 33% of the length of the heater element relative to the proximal end.

Example Ex12: An elongate metallic heater element according to Ex11, in which at least 40% by volume, or at least 50% by volume, or at least 60% by volume, or at least 70% by volume, or at least 80% by volume of all of the plurality of surface notches and sub-surface cavities of the heater element are provided in the inner region.

Example Ex13: An elongate metallic heater element according to either one of Ex11 or Ex12, in which the surface notches and sub-surface cavities of the inner region extend laterally across at least 90%, or at least 95% of the lateral width of the heater element.

Example Ex14: An elongate metallic heater element according to any one of Ex11 to Ex13, in which all of the plurality of surface notches and sub-surface cavities of the heater element are provided in the inner region of the heater element.

Example Ex15: An elongate metallic heater element according to any one of Ex11 to 14, in which some of the plurality of surface notches and sub-surface cavities of the heater element are provided in a middle region of the heater element, the middle region extending between 33% and 90% of the length of the elongate heater element relative to the proximal end.

Example Ex16: An elongate metallic heater element according to any one of Ex1 to Ex15, in which the heater element extends along a longitudinal axis and laterally outwards from the longitudinal axis to define a blade having opposed first and second elongate surfaces.

Example Ex17: An elongate metallic heater element according to Ex16, the heater element further comprising a resistive heating track arranged on the first elongate surface, the heater element comprising a plurality of the surface notches on the second elongate surface, in which the surface notches on the second elongate surface form at least 80% by volume of all of the plurality of surface notches of the heater element.

Example Ex18: An elongate metallic heater element according to Ex17, in which the first elongate surface is substantially free of surface notches.

Example Ex19: An elongate metallic heater element according to any one of Ex16 to Ex18, in which the plurality of surface notches and sub-surface cavities of the heater element are arranged in one or more laterally-symmetric groups.

Example Ex20: An elongate metallic heater element according to Ex19, in which the one or more laterally-symmetric groups comprise: a first group symmetrically disposed about the longitudinal axis and extending laterally across at least 90%, or at least 95% of the lateral width of the heater element in an inner region of the heater element, the inner region extending between the proximal end and 33% of the length of the heater element relative to the proximal end; second and third groups symmetrically disposed from each other on either side of the longitudinal axis in a middle region of the heater element, the middle region extending between 33% and 90% of the length of the heater element relative to the proximal end.

Example Ex21: An elongate metallic heater element according to Ex20, in which the second and third groups join each other at the longitudinal axis.

Example Ex22: An elongate metallic heater element according to any one of Ex1 to Ex21, in which the heater element is configured to be removably mountable to the aerosol-generating device.

Example Ex23: An aerosol-generating device configured to receive an aerosol-forming substrate, the aerosol-generating device comprising an elongate metallic heater element according to any one of Ex1 to Ex22 and a power source, the proximal end of the heater element mounted to a mounting location of the aerosol-generating device, the power source in electrical communication with the heater element so as to, in use, resistively heat the heater element.

Example Ex24: An aerosol-generating device according to Ex23, in which the aerosol-generating device is configured such that, in use with an aerosol-forming substrate received in the device, the heater element extends within the aerosol-forming substrate so as to heat the aerosol-forming substrate and generate an inhalable aerosol therefrom.

Example Ex25: A method of manufacturing a heater element, the method comprising: providing a metallic substrate and forming either or both of: i) a plurality of surface notches on a surface of the metallic substrate; and ii) a plurality of sub-surface cavities defined beneath the surface of the metallic substrate.

Example Ex26: A method of manufacturing a heater element according to Ex25, in which the forming step comprises etching of the metallic substrate to form the plurality of surface notches.

Example Ex27: A method of manufacturing a heater element, the method comprising: providing a supply of metallic material; additively manufacturing the heater element from the supply of metallic material to progressively form the heater element to comprise either or both of: i) a plurality of surface notches on a surface of the heater element; and ii) a plurality of sub-surface cavities defined beneath the surface of the heater element.

Example Ex28: A method of manufacturing a heater element according to Ex27, in which the additive manufacturing step comprises three-dimensional screen printing.

Example Ex29: A method of manufacturing a heater element according to any one of Ex25 to Ex28, in which the manufactured heater element resulting from the method is in accordance with any one of Ex1 to Ex22.

Examples will now be further described with reference to the figures, in which:

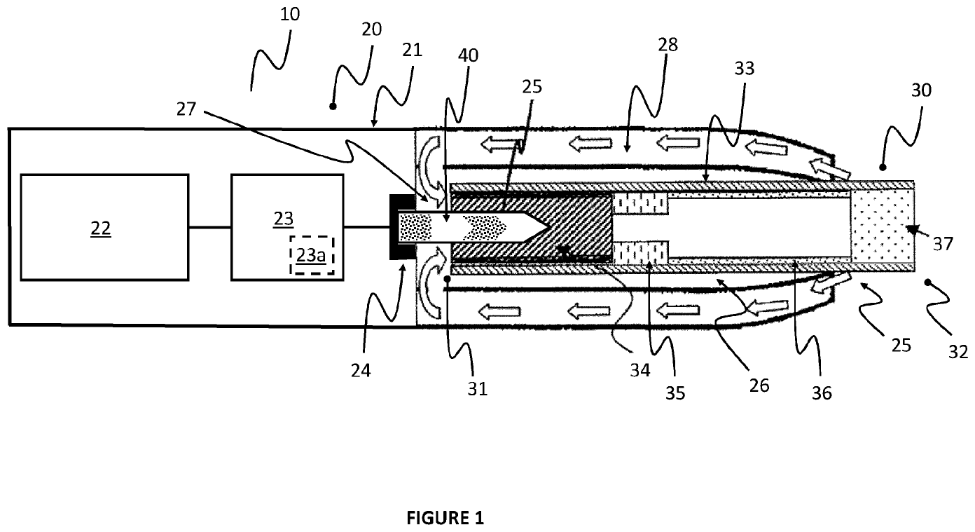

FIG. 1 is a schematic view of the components of an aerosol-delivery system.

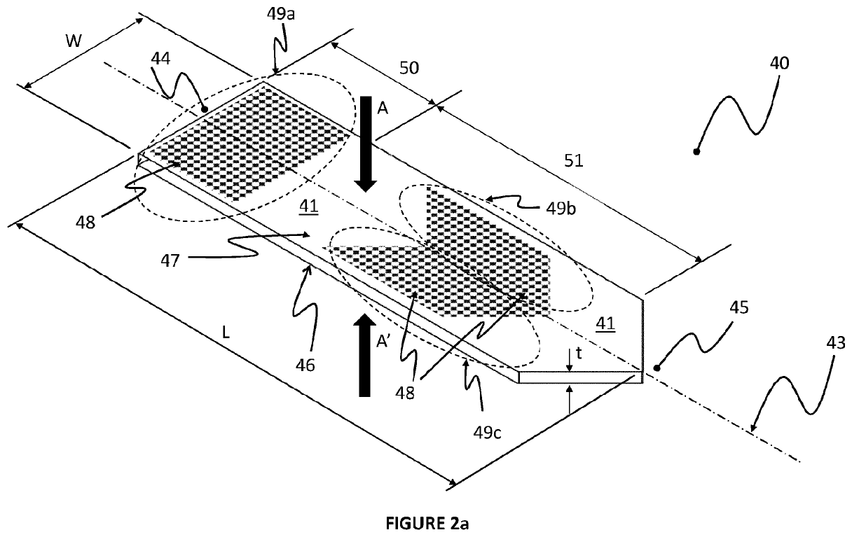

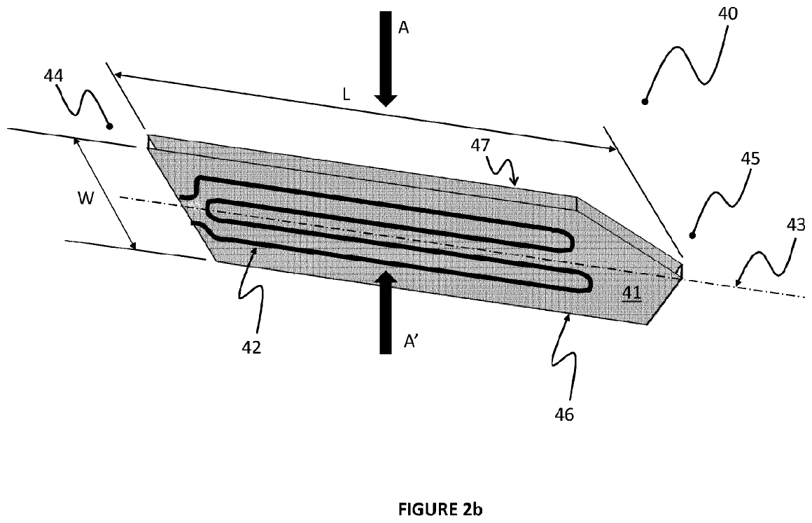

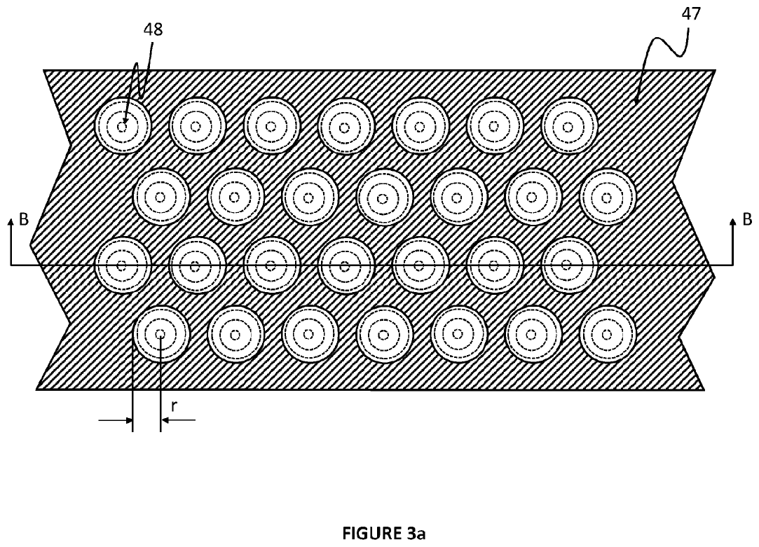

FIG. 2a is a perspective view from above of a heater element used in an aerosol-generating device of the aerosol-delivery system of FIG. 1, in which a plurality of surface notches are defined on a surface of the heater element.

FIG. 2b is a perspective view from below of the heater element of FIG. 2a.

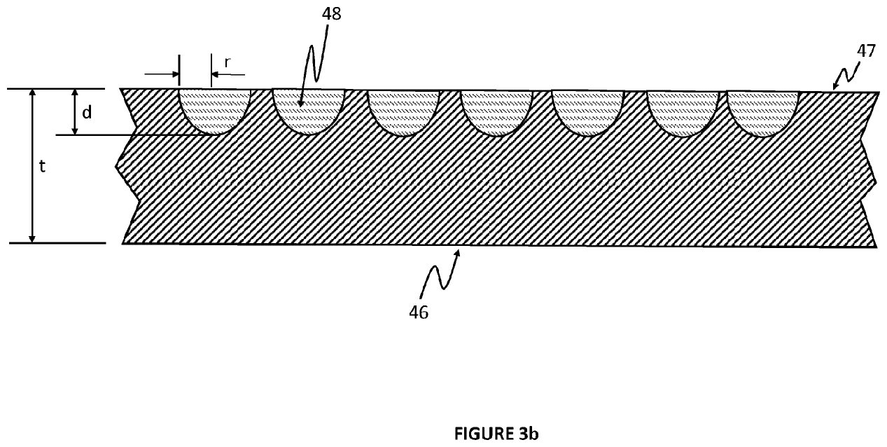

FIG. 3a is a detail plan view of a portion of the upper surface of an exemplary heater element in accordance with the present disclosure, in which the heater element is provided with an arrangement of surface notches which are circular in plan and extend into the upper surface of the heater element to form notches which are part-spherical in form.

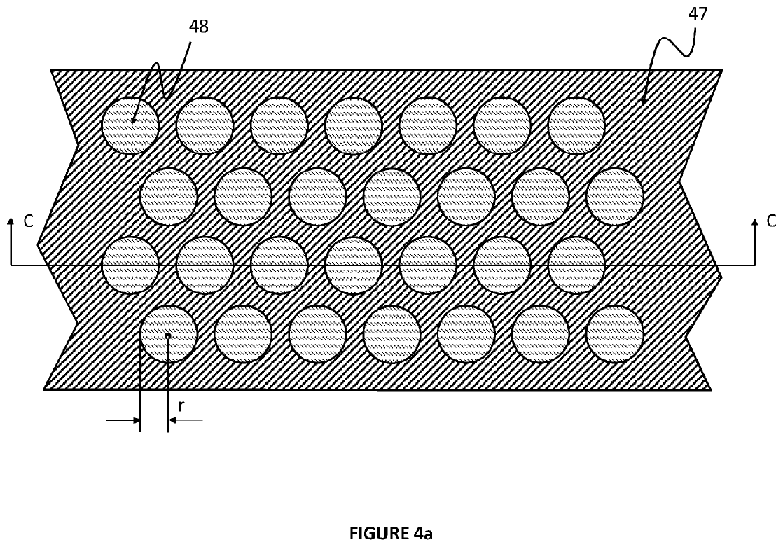

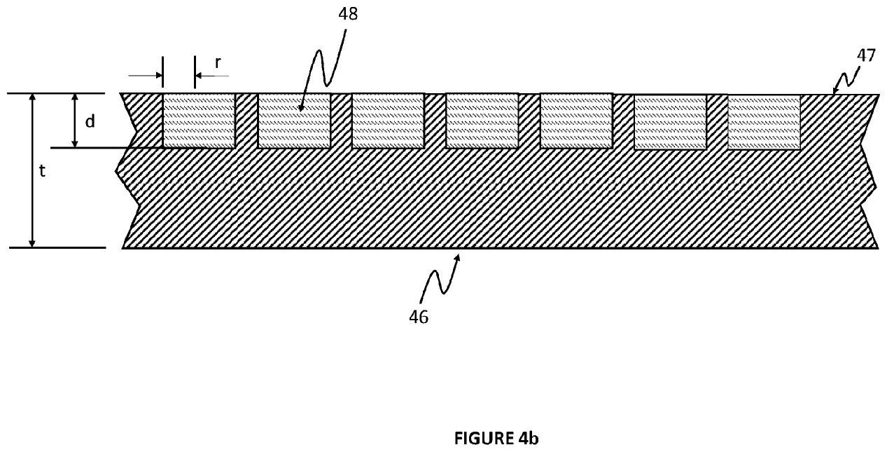

FIG. 3b is a sectional view along section B-B of the heater element portion of FIG. 3a. FIG. 4a is a detail plan view of the upper surface of a portion of another exemplary heater element in accordance with the present disclosure, in which the heater element is provided with an arrangement of surface notches which are circular in plan with a cylindrical bore extending into the upper surface of the heater element.

FIG. 4b is a sectional view along section C-C of the heater element portion of FIG. 4a, showing how the cylindrical bore of each surface notch extends into the upper surface of the heater element.

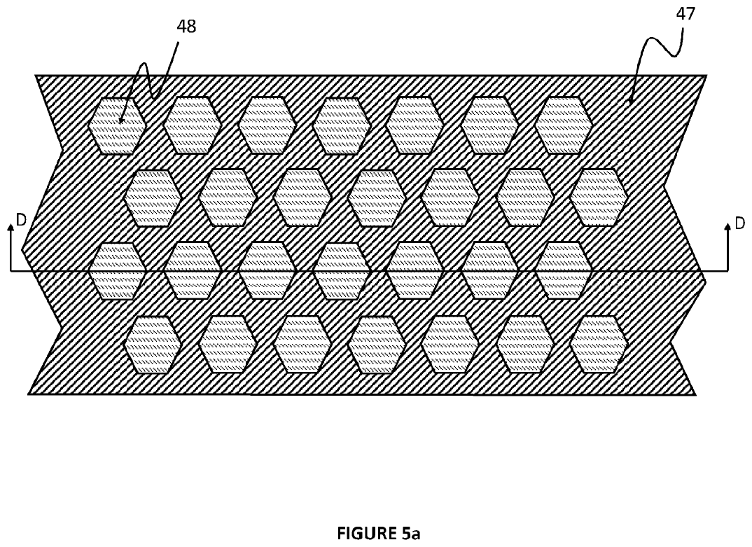

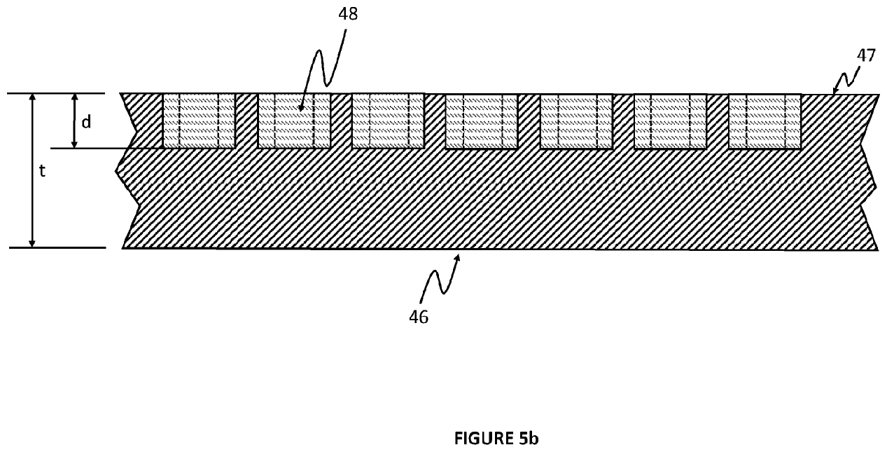

FIG. 5a is a detail plan view of the upper surface of a portion of another exemplary heater element in accordance with the present disclosure, in which the heater element is provided with an arrangement of surface notches which are hexagonal in plan with a hexagonal bore extending into the upper surface of the heater element.

FIG. 5b is a sectional view along section D-D of the heater element portion of FIG. 5a, showing how the hexagonal bore of each surface notch extends into the upper surface of the heater element.

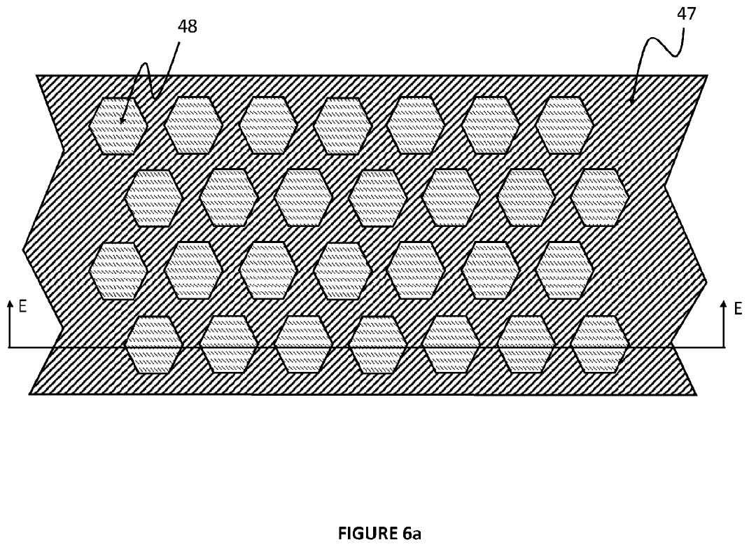

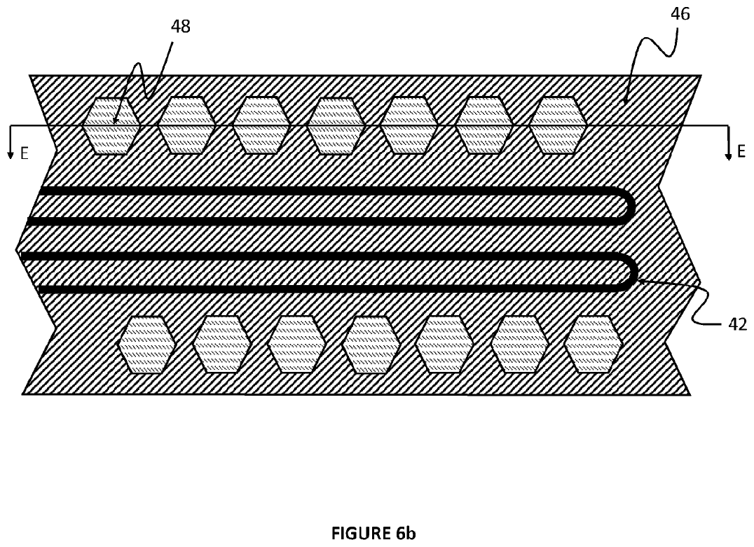

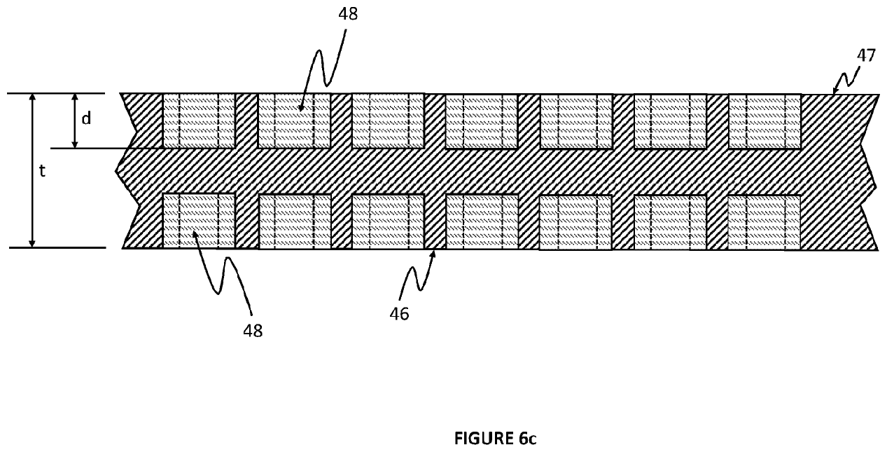

FIG. 6a is a detail plan view of the upper surface of a portion of another exemplary heater element in accordance with the present disclosure, in which the heater element is provided with an arrangement of surface notches which are hexagonal in plan with a hexagonal bore extending into the upper surface of the heater element.

FIG. 6b is a detail plan view of the lower surface of the portion of the heater element of FIG. 6a, in which both a resistive heating track and an arrangement of surface notches which are hexagonal in plan are provided on the lower surface of the heater element.

FIG. 6c is a sectional view along section E-E of the heater element portion of FIGS. 6a and 6b, showing how the hexagonal bore of the surface notches extends into both the upper and lower surfaces of the heater element.

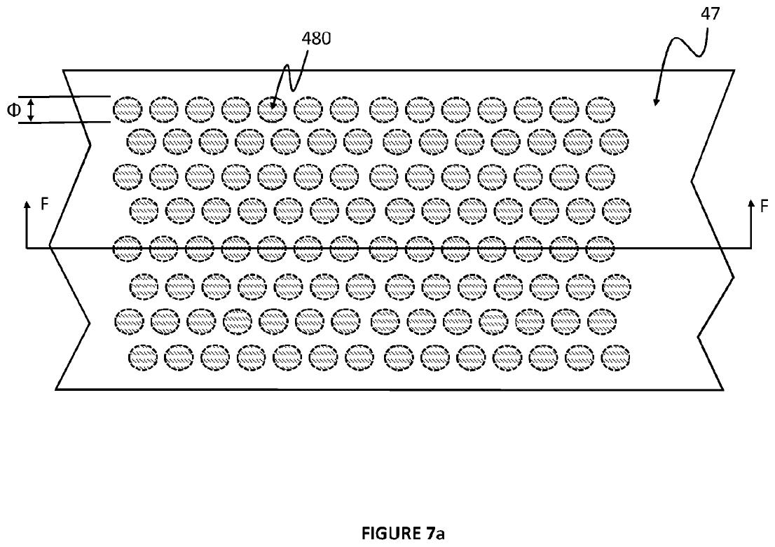

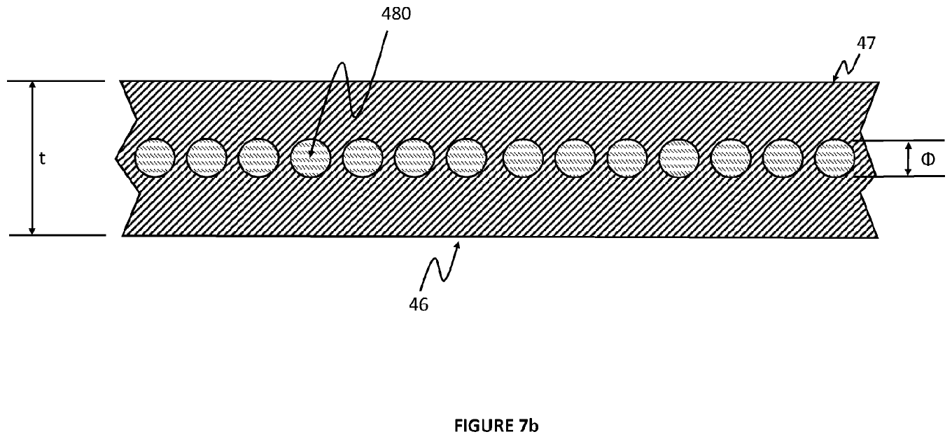

FIG. 7a is a detail plan view of the upper surface of a portion of another exemplary heater element in accordance with the present disclosure, in which the heater element is provided with an arrangement of sub-surface cavities which are spherical in form.

FIG. 7b is a sectional view along section F-F of the heater element portion of FIG. 7a, showing how the cavities are arranged in a single sub-surface layer embedded within the heater element.

FIG. 8 is a sectional view of a variation to the heater element of FIGS. 7a and 7b (along section F-F), in which the heater element is provided with an arrangement of three layers of sub-surface cavities embedded within the heater element.

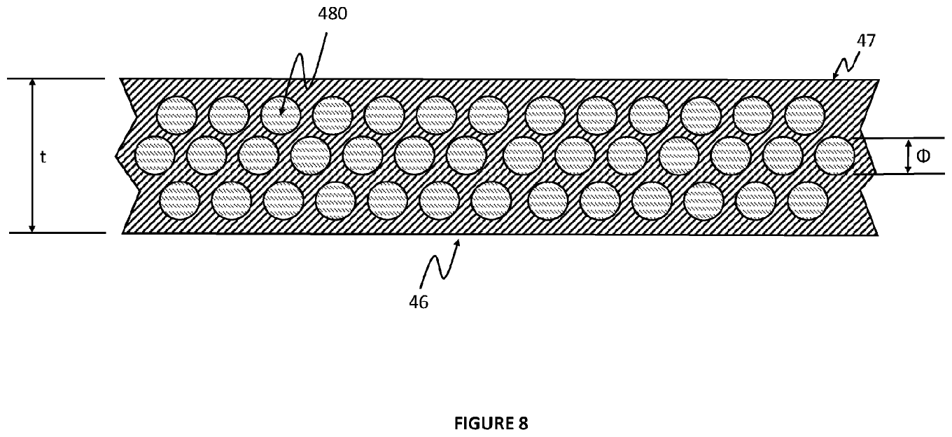

FIG. 9 is a sectional view of another heater element, being a combination of the examples of FIGS. 5a,b and 7a,b in that an arrangement of surface notches which are hexagonal in plan is provided on an upper surface of the heater element and an arrangement of spherical sub-surface cavities is provided as a single layer embedded within the heater element.

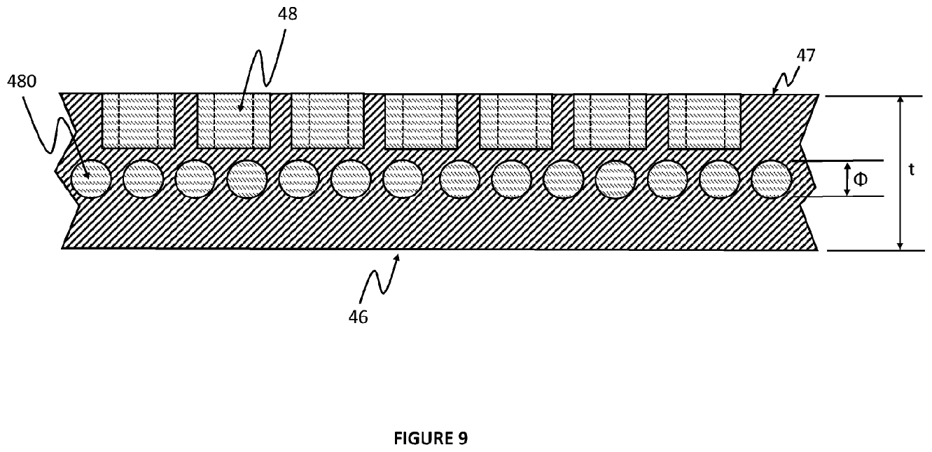

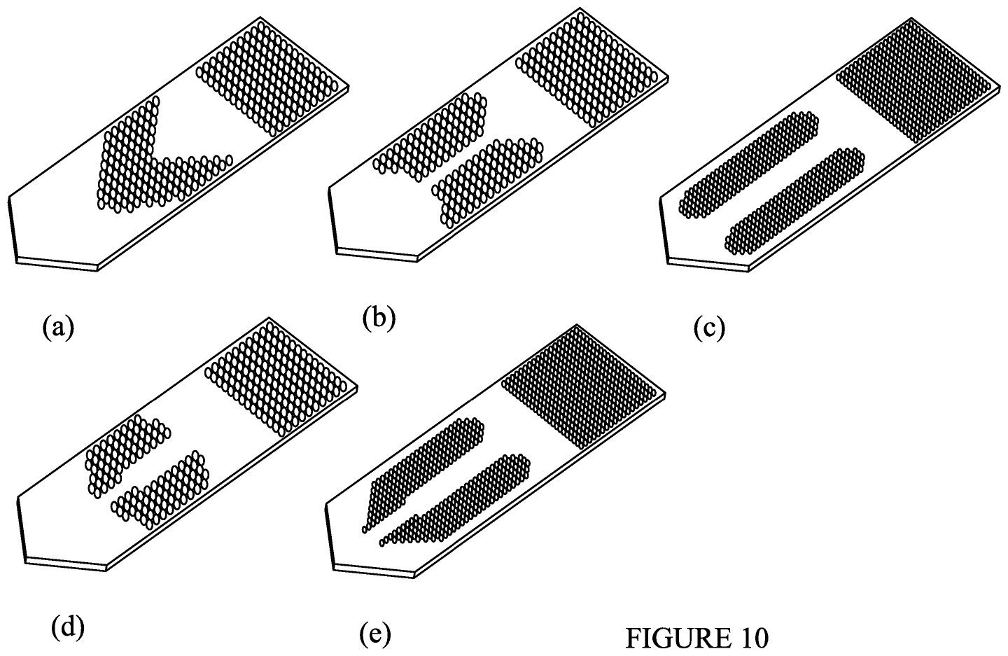

FIG. 10 is a perspective view of five different heater elements, each having different arrangements of surface notches.

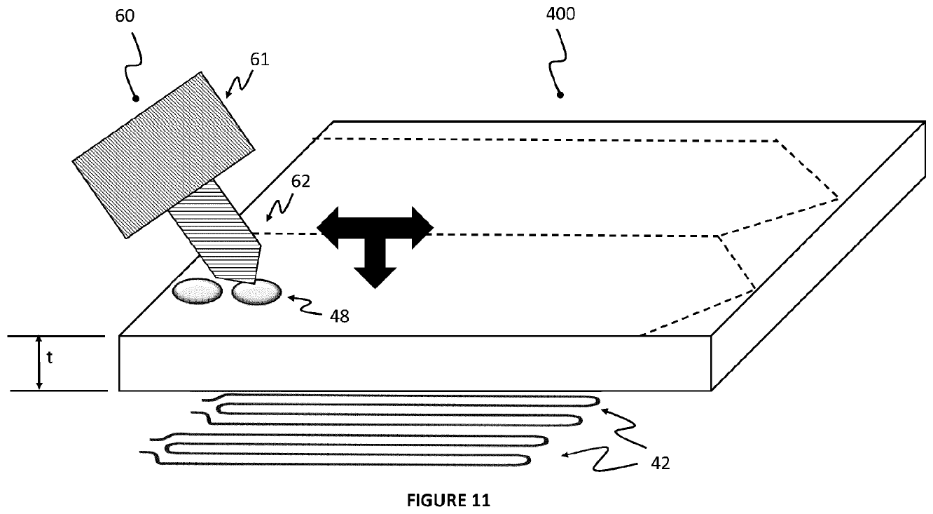

FIG. 11 is a schematic view of a machining assembly for manufacturing multiple heater elements from a sheet of metallic substrate.

FIG. 1 is a schematic view of an aerosol-delivery system 10. The aerosol-generating system 10 is a smoking system for generating an inhalable aerosol. The system 10 is formed of a combination of an aerosol-generating device 20 and an aerosol-generating article 30.

The aerosol-generating device 20 has an elongate housing 21 formed of a polymer material. The elongate housing 21 contains a power source 22, a controller 23 and a mounting location 24. A metallic heater element 40 is detachably mounted to the mounting location 24 by use of a push-fit connection. The heater element 40 is formed of a metallic substrate 41 and has a resistive heating track 42 overlaid on a surface of the substrate (see, for example, FIG. 2b). The structure of the heater element 40 is described in more detail in subsequent paragraphs. The heater element 40 is mounted to the mounting location 24 so that the resistive heating track 42 is electrically coupled to the mounting location. An access opening 25 is provided at one end of the elongate housing 21. A blind cavity 26 extends from the access opening 25 into the interior of the elongate housing 21. The heater element 40 extends from a closed end 27 of the blind cavity 26 towards the access opening 25.

The aerosol-generating article 30 is cylindrical in form and extends between a distal end 31 and a mouth end 32. The aerosol-generating article 30 has a wrapper 33. The wrapper 33 is in the form of a cigarette paper. A plug of aerosol-forming substrate 34, a hollow acetate tube 35, a tubular spacer element 36 and a mouthpiece filter 37 are co-axially and sequentially arranged within the wrapper 33. The aerosol-generating article 30 is received within the blind cavity 26 such that the heater element 40 inserts within the plug of aerosol-forming substrate 34.

For the aerosol-generating device 20, the power source 22 is coupled to the controller 23 to provide power thereto. For the example shown, the power source 22 is a rechargeable lithium ion battery. The controller 23 is coupled to the mounting location 24 to provide electric current to the mounting location 24 and thereby to the resistive heating track 42 of the heater element 40. The controller 23 is in the form of control electronics and incorporates a memory module 23a. The memory module 23a contains instructions accessible by a processor (not shown) of the controller 23 to control the supply of electric current to the resistive heating track 42 of the heater element 40. Electric current fed from the controller 23 to the mounting location 24 results in resistive heating of the resistive heating track 42. Some of the heat generated by the resistive heating track 42 is conducted into the underlying metallic substrate 41 of the heater element 40.

In use, heat generated by the heater element 40 is conveyed to the plug of aerosol-forming substrate 34. The heating of the aerosol-forming substrate 34 results in vapours being evolved from the aerosol-forming substrate. In response to a user drawing on the mouth end 32 of the article 30, a flow of ambient air (as indicated by arrows in FIG. 1) is sucked into an air passageway 28 circumferentially arranged between the elongate housing 21 and the blind cavity 26. The flow of air then enters the distal end 31 of the aerosol-generating article 30 and passes through the plug of aerosol-forming substrate 34 to mix with the vapours evolved from the aerosol-forming substrate. The vapour mixture then passes downstream through the interior of the aerosol-generating article 30 towards the mouth end 32, during which time the vapour condenses to form aerosol. The aerosol passes through the mouthpiece filter 37, from where it is inhaled into the lungs of the user.

FIGS. 2a and 2b show perspective views from of the upper and lower surfaces respectively of the heater element 40 used in the aerosol-delivery system 10 of FIG. 1. The terms “upper” and “lower” are used in a relative sense only. As stated above, the heater element 40 is formed of a metallic substrate 41. The metallic substrate 41 is titanium or stainless steel. However, in alternative examples, the metallic substrate 41 may be formed of other metals or alloys. The resistive heating track 42 is overlaid on a surface of the metallic substrate 41 (see FIG. 2b). For the example shown in FIGS. 2a and 2b, the resistive heating track 42 is in the form of fine metal wire deformed into a coil shape. However, in alternative examples (not shown), the resistive heating track 41 may take other forms, such as being a metal sheet which has been stamped or otherwise formed into a coil-shaped pattern. The metallic substrate 41 of the heater element 40 extends longitudinally along axis 43 between proximal end 44 and distal end 45, plus laterally outwards from the axis to define a blade-shaped profile for the heater element 40. The heater element 40 is detachably mounted to the mounting location 24 at proximal end 44. First and second planar surfaces 46, 47 define respective lower and upper surfaces of the metallic substrate 41. The resistive heating track 42 is arranged on the lower surface 46 (see FIG. 2b). A plurality of surface notches 48 are formed on the upper surface 47. The surface notches 48 extend partially through the thickness, t, of the metallic substrate 41. The plurality of surface notches 48 are arranged in three groups 49a,b,c. Group 49a of surface notches 48 are provided in an inner region 50 of the heater element 40, the inner region extending between the proximal end 44 and approximately 33% of the length, L, of the heater element relative to the proximal end. For the example shown in FIG. 2a, approximately 40% of all of the surface notches 48 formed on the heater element 40 are located in this inner region 50 in group 49a. Groups 49b and 49c contain the remaining 60% of the surface notches 47 formed on the heater element 40, with both groups being laterally symmetric about axis 43 in a middle region 51 of the heater element. The middle region 51 extends between 33% and 90% of the length, L, of the heater element 40 relative to the proximal end 44. These two laterally symmetric groups 49b and 49c of surface notches 48 join at axis 43 to define an arrowhead shape when viewed in plan, i.e. in the direction of arrow A. The surface notches 48 of group 49a extend across in excess of 95% of the lateral width, W, of the heater element 40. For the heater element 40 of FIGS. 2a and 2b, no surface notches 48 are defined on the lower surface 46 of the metallic substrate 41. However, in alternative examples (such as the exemplary heater element of FIGS. 6a-c, discussed in subsequent paragraphs), a plurality of surface notches 48 is also provided on the lower surface 46 of the metallic substrate 41.

For the heater element of FIGS. 2a and 2b, the surface notches 48 defined on the heater element 40 occupy a cumulative volume of ˜18% of a corresponding heater element free of any such notches. This provides ˜18% mass reduction relative to such a corresponding heater element free of any such notches. In alternative examples, the surface notches 48 occupy a larger or smaller cumulative volume according to the degree of heat flow management desired. Further, in alternative examples (not shown), the distribution of surface notches 48 along the length, L, and across the width, W, of the heater element 40, and the proportion of surface notches 48 in the inner and middle regions 50, 51 may differ from that shown and discussed for the heater element of FIGS. 2a and 2b.

FIGS. 3 to 9 show views of portions of various exemplary heater elements 40 having differing arrangements of surface notches or sub-surface cavities to the heater element illustrated in FIGS. 2a,b. For convenience, features common to the various exemplary heater elements 40 are referred to using like reference signs.

FIG. 3a is a plan view (in the direction of arrow A of FIG. 2a) of the upper surface 47 of a portion of an exemplary heater element 40. A plurality of surface notches 48 are formed on the upper surface 47 of the metallic substrate 41. The surface notches 48 are circular in plan, being of radius, r. The surface notches 48 are formed in a repeating honeycomb-type pattern, in which adjacent rows of the notches are offset from each other. As shown in the sectional view of FIG. 3b, each of the surface notches 48 extends into the upper surface 47 of the metallic substrate 41 to provide a notch surface profile which is part-spherical. Each notch 48 extends part way through the thickness, t, of the substrate 41 for a depth, d (see FIG. 3b). As the notch surface profile is part-spherical, the depth d equates to radius r. In alternative examples (not shown), the surface profile of the notches 48 is ellipsoidal. In further alternative examples (not shown), the dimensions of the notches 48 are varied in different regions of the heater element 40. Further, the spacing between adjacent notches 48 may be varied in different regions of the heater element 40. By way of example, with reference to FIG. 2a, the notches 48 in inner region 50 may be larger or spaced closer together than those in middle region 51. Such variation in notch dimensions and spacing between adjacent notches 48 in different regions of the heater element 40 can be used to provide different levels of thermal conductivity in those different regions.

FIG. 4a is a plan view (in the direction of arrow A of FIG. 2a) of the upper surface of a portion of another exemplary heater element 40. A plurality of surface notches 48 are formed on the upper surface 47 of the metallic substrate 41. In common with the example of FIGS. 3a,b, the surface notches 48 are circular in plan, being of radius, r, and formed in a repeating honeycomb-type pattern, in which adjacent rows of the notches are offset from each other. However, as shown in the sectional view of FIG. 4b, each of the surface notches 48 has a cylindrical bore which extends into the upper surface 47 of the metallic substrate 41 to provide a notch surface profile which is cylindrical. Each notch 48 extends part way through the thickness, t, of the substrate 41 for a depth, d (see FIG. 4b). In alternative examples (not shown), the dimensions of the notches 48 are varied in different regions of the heater element 40. Further, the spacing between adjacent notches 48 may be varied in different regions of the heater element 40. By way of example, with reference to FIG. 2a, the notches 48 in inner region 50 may be larger or spaced closer together than those in middle region 51. Such variation in notch dimensions and spacing between adjacent notches 48 in different regions of the heater element 40 can be used to provide different levels of thermal conductivity in those different regions.

FIG. 5a is a plan view (in the direction of arrow A of FIG. 2a) of the upper surface 47 of a portion of an exemplary heater element 40. A plurality of surface notches 48 are formed on the upper surface 47 of the metallic substrate 41. The surface notches 48 are hexagonal in plan. The surface notches 48 are formed in a repeating honeycomb-type pattern, in which adjacent rows of the notches are offset from each other. As shown in the sectional view of FIG. 5b, each of the surface notches 48 has a hexagonal bore which extends into the upper surface 47 of the metallic substrate 41. Each notch 48 extends part way through the thickness, t, of the substrate 41 for a depth, d (see FIG. 5b). In alternative examples (not shown), the dimensions of the notches 48 are varied in different regions of the heater element 40. Further, the spacing between adjacent notches 48 may be varied in different regions of the heater element 40. By way of example, with reference to FIG. 2a, the notches 48 in inner region 50 may be larger or spaced closer together than those in middle region 51. Such variation in notch dimensions and spacing between adjacent notches 48 in different regions of the heater element 40 can be used to provide different levels of thermal conductivity in those different regions.

FIG. 6a is a plan view (in the direction of arrow A of FIG. 2a) of the upper surface 47 of a portion of an exemplary heater element 40. The notch arrangement on the upper surface 47 is identical to that of the heater element 40 of FIG. 5a, with a plurality of surface notches 48 formed on the upper surface of the metallic substrate 41. The surface notches 48 are hexagonal in plan and formed in a repeating honeycomb-type pattern, in which adjacent rows of the notches are offset from each other. However, the heater element of this example differs from that of FIGS. 5a,b in that an arrangement of surface notches 48 are also provided on the lower surface 46 of the metallic substrate 41. As for the notches on the upper surface 47, the notches on the lower surface 46 are hexagonal in plan. However, the notches 48 on the lower surface 46 are fewer in number than those on the upper surface 47. As can be seen in FIG. 6b, the notches 48 on the lower surface 46 are positioned on either side of the resistive heating track 42. As shown in the sectional view of FIG. 6c, each notch 48 extends part way through the thickness, t, of the substrate 41 for a depth, d. In alternative examples (not shown), the dimensions of the notches 48 are varied in different regions of the heater element 40. Further, the spacing between adjacent notches 48 may be varied in different regions of the heater element 40. By way of example, with reference to FIG. 2a, the notches 48 in inner region 50 may be larger or spaced closer together than those in middle region 51. Such variation in notch dimensions and spacing between adjacent notches 48 in different regions of the heater element 40 can be used to provide different levels of thermal conductivity in those different regions.

FIG. 7a is a plan view (in the direction of arrow A of FIG. 2a) of the upper surface 47 of a portion of an exemplary heater element 40. In contrast to the exemplary heater elements 40 of FIGS. 3 to 6, no surface notches 48 are provided on the metallic substrate. Rather, a layer of spherical sub-surface cavities 480 is embedded within the metallic substrate 41, each cavity having diameter, Φ(see the sectional view of FIG. 7b). The outline of these sub-surface cavities 480 is shown with a dashed line in the plan view of FIG. 7a. The sub-surface cavities 480 are formed in a repeating honeycomb-type pattern, in which adjacent rows of the embedded cavities 480 are offset from each other (see FIG. 7a). In alternative examples (not shown), the sub-surface cavities 480 are ellipsoidal in form. In further alternative examples (not shown), the dimensions of the sub-surface cavities 480 are varied in different regions of the heater element 40. Further, the spacing between adjacent cavities 480 may be varied in different regions of the heater element 40. By way of example, with reference to FIG. 2a, sub-surface cavities 480 in inner region 50 may be larger or spaced closer together than those in middle region 51. Such variation in cavity dimensions and spacing between adjacent sub-surface cavities 480 in different regions of the heater element 40 can be used to provide different levels of thermal conductivity in those different regions.

FIG. 8 is a sectional view of a heater element 40 similar to that shown in FIG. 7b, but differing in that three layers of sub-surface cavities 480 are embedded within the metallic substrate 41. In alternative examples (not shown), where multiple layers of sub-surface cavities 480 are embedded within the metallic substrate 41, the layers may differ from each other in terms of the size or spacing of the cavities 480 in each layer.

FIG. 9 is a sectional view of a heater element 40 corresponding to a combination of the examples of FIGS. 5a,b and 7a,b. As can be seen, an arrangement of surface notches 48 are formed on the upper surface 47 of the metallic substrate 41, the notches being hexagonal in plan (as per FIG. 5a). However, in addition, a layer of sub-surface cavities 480 is embedded in the metallic substrate 41 (as per FIG. 7a).

FIG. 10 shows a perspective view of five different heater elements 40, each having different arrangements of surface notches 48.

FIG. 11 is a schematic view of a machining assembly 60 for manufacturing a heater element from a sheet 400 of the metallic substrate 41 material. The machining assembly 60 has a tool holder 61 holding a machining tool 62. The sheet 400 of metallic substrate is provided and secured in position relative to the machining assembly 60. The sheet 400 has a thickness corresponding to the desired thickness, t, of the heater elements 40 described in the previous paragraphs, but has a width and a length sufficient for multiple heater elements 40 to be formed from a single sheet 400. The machining assembly 60 operates the machining tool 62 to machine an individual surface notch 48 in the upper surface of the metal sheet 400 and then traverses (see arrows in FIG. 11) the tool holder 61 and machining tool 62 over the surface of the metal sheet 400 to repeat the machining operation at multiple desired locations. Once the machining operation is completed, resistive heater tracks 62 are arranged at predetermined intervals on the lower surface of the sheet 400. Individual heater elements 40 are then cut from the sheet 400, with dashed lines in FIG. 11 showing the outline of two such heater elements 40. In another example (not shown), the surface notches 48 are chemically etched in the surface of the metal sheet 400, rather than being mechanically formed.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. An elongate metallic heater element for an aerosol-generating device,
the elongate metallic heater element extending between a proximal end and a distal end, the proximal end configured for mounting to the aerosol-generating device for electrical communication with the aerosol-generating device,
wherein the elongate metallic heater element comprises either or both of:
a plurality of surface notches formed on a surface of the elongate metallic heater element, and
a plurality of sub-surface cavities defined beneath the surface of the elongate metallic heater element,
wherein at least some of the plurality of surface notches and the plurality of sub-surface cavities of the elongate metallic heater element are provided in an inner region of the elongate metallic heater element, the inner region extending between the proximal end and 33% of a length of the elongate metallic heater element relative to the proximal end, and
wherein at least 40% by volume, or at least 50% by volume, or at least 60% by volume, or at least 70% by volume, or at least 80% by volume of all of the plurality of surface notches and the plurality of sub-surface cavities of the elongate metallic heater element are provided in the inner region.

17. The elongate metallic heater element according to claim 16, wherein the plurality of surface notches and the plurality of sub-surface cavities of the elongate metallic heater element occupy a cumulative volume of between 15% to 30% of a volume of a corresponding heater element free of any such notches and cavities.

18. The elongate metallic heater element according to claim 16, wherein the plurality of surface notches and the plurality of sub-surface cavities of the elongate metallic heater element occupy a cumulative volume of between 17% to 26% of a volume of a corresponding heater element free of any such notches and cavities.

19. The elongate metallic heater element according to claim 16, further comprising a plurality of through-holes extending through a thickness of the elongate metallic heater element.

20. The elongate metallic heater element according to claim 16, wherein the plurality of surface notches and the plurality of sub-surface cavities of the elongate metallic heater element are formed to define one or more honeycomb arrangements.

21. The elongate metallic heater element according to claim 16, wherein the elongate metallic heater element comprises the plurality of surface notches and is free of any sub-surface cavities.

22. The elongate metallic heater element according to claim 16, wherein the elongate metallic heater element comprises the plurality of sub-surface cavities and is free of any surface notches.

23. The elongate metallic heater element according to claim 16, wherein the surface notches and sub-surface cavities of the inner region extend laterally across at least 90%, or at least 95%, of a lateral width of the elongate metallic heater element.

24. The elongate metallic heater element according to claim 16, wherein all of the plurality of surface notches and the plurality of sub-surface cavities of the elongate metallic heater element are provided in the inner region of the elongate metallic heater element.

25. The elongate metallic heater element according to claim 16, wherein some of the plurality of surface notches and the plurality of sub-surface cavities of the elongate metallic heater element are provided in a middle region of the elongate metallic heater element, the middle region extending between 33% and 90% of a length of the elongate metallic heater element relative to the proximal end.

26. The elongate metallic heater element according to claim 16, wherein the elongate metallic heater element extends along a longitudinal axis and laterally outwards from the longitudinal axis to define a blade having opposed first and second elongate surfaces.

27. The elongate metallic heater element according to claim 26, further comprising:
a resistive heating track arranged on the first elongate surface; and
a plurality of the surface notches on the second elongate surface,
wherein the surface notches on the second elongate surface form at least 80% by volume of all of the plurality of surface notches of the elongate metallic heater element.

28. The elongate metallic heater element according to claim 26, wherein the plurality of surface notches and the plurality of sub-surface cavities of the elongate metallic heater element are arranged in one or more laterally-symmetric groups.

29. An aerosol-generating device configured to receive an aerosol-forming substrate, the aerosol-generating device comprising:
an elongate metallic heater element according to claim 16; and
a power source,
wherein the proximal end of the elongate metallic heater element is mounted to a mounting location of the aerosol-generating device, and the power source is in electrical communication with the elongate metallic heater element so as to, in use, resistively heat the elongate metallic heater element.

30. The aerosol-generating device according to claim 29, wherein the aerosol-generating device is configured such that, in use with an aerosol-forming substrate received in the aerosol-generating device, the elongate metallic heater element extends within the aerosol-forming substrate so as to heat the aerosol-forming substrate and generate an inhalable aerosol therefrom.
